(19) United States
(12) Patent Application Publication
(10) Pub. No.: US 2026/0080796 A1
(43) Pub. Date: Mar. 19, 2026

(54) STORAGE MEDIUM, LEARNING SUPPORT SYSTEM, AND DISPLAY CONTROL METHOD

(71) Applicant: CASIO COMPUTER CO., LTD., Tokyo (JP)

(72) Inventor: Masashi UEDA, Tokyo (JP)

(73) Assignee: CASIO COMPUTER CO., LTD., Tokyo (JP)

(21) Appl. No.: 19/321,738

(22) Filed: Sep. 8, 2025

(30) Foreign Application Priority Data
Sep. 17, 2024 (JP) 2024-159774

(51) Int. Cl. G09B 7/04; G09B 5/02

(52) U.S. Cl. CPC G09B 7/04; G09B 5/02

(57) ABSTRACT

A non-transitory computer-readable storage medium storing a computer program readable by a computer of a display control apparatus is shown. The program executed by the computer causes the display control apparatus to: based on a progress status of an input of an answer to a question by a learner with relation to a complete answer to the question, generate data for displaying on a display advice information used for solving the question.

### CROSS-REFERENCE TO RELATED APPLICATIONS

This application claims priority and benefit of Japanese Patent Application No. 2024-159774, filed on September 17, 2024. The entire specification, claims, and drawings of Japanese Patent Application No. 2024-159774 are incorporated herein by reference.

### BACKGROUND OF THE INVENTION

### FIELD OF THE INVENTION

The present disclosure relates to a storage medium, learning support system, and display control method.

### DESCRIPTION OF THE RELATED ART

In the past, learning devices have been used to support a user’s learning process by displaying questions on a display screen and accepting answers to the questions. According to Japanese Unexamined Patent Application Publication No. 2007-065169, a technique is disclosed that displays headwords and similar questions that have a predetermined relationship with words in an answer as hints for fill-in-the-blank questions.

### SUMMARY

To solve the above problem, a non-transitory computer-readable storage medium storing a computer program readable by a computer of a display control apparatus, wherein the program executed by the computer causes the display control apparatus to: based on a progress status of an input of an answer to a question by a learner with relation to a complete answer to the question, generate data for displaying on a display advice information used for solving the question.

### BRIEF DESCRIPTION OF THE DRAWING

FIG. 1 shows an example configuration of a learning support system according to a first embodiment of the present disclosure.

FIG. 2 shows an example configuration of a database provided in a region of a storage of a server device.

FIG. 3 shows an example of a data structure of a hint table.

FIG. 4 shows an example of the data structure of a question correct/wrong table.

FIG. 5 is a ladder chart showing a learning support process executed in the learning support system.

FIG. 6 shows an example of an initial state of an answer input screen.

FIG. 7 shows an example of the answer input screen in a state in which an equation of a question statement is input in a calculation process input field.

FIG. 8 is an example of the answer input screen in a case in which a hint button is pressed in the state shown in FIG. 7.

FIG. 9 is an example of the answer input screen in a state in which a square completed equation is input in the calculation process input field.

FIG. 10 is an example of the answer input screen in a case in which the hint button is pressed in the state shown in FIG. 9.

FIG. 11 is an example of a display of a hint on the answer input screen in modification example 1.

FIG. 12 is an example of the display of the hint on the answer input screen in modification example 1.

FIG. 13 is a flowchart showing a hint presentation process in modification example 2.

FIG. 14 is an example of a current status selection screen.

FIG. 15 is an example of the display of the hint on the answer input screen in modification example 2.

FIG. 16 is an example of the display of the hint on the answer input screen in modification example 2.

FIG. 17 is a flowchart showing the hint presentation process in modification example 3.

FIG. 18 shows an example of the answer input screen in a state in which the hint button is displayed as disabled.

FIG. 19 shows an example of the answer input screen in a state in which the hint button is displayed as disabled.

FIG. 20 is a flowchart showing the hint presentation process according to the second embodiment.

FIG. 21 is an example of the answer input screen with the hint displayed as a result of automatic analysis of the calculation process.

FIG. 22 is a flowchart showing the hint presentation process according to the third embodiment.

FIG. 23 is a flowchart showing the hint presentation process according to the fourth embodiment.

FIG. 24 shows an example of the answer input screen with only a final answer (correct answer) input.

FIG. 25 is a display example of a correct answer notification screen.

FIG. 26 is a display example of the correct answer notification screen.

FIG. 27 shows an example of the answer input screen with only the final answer (incorrect answer) input.

FIG. 28 is a display example of an incorrect answer notification screen.

FIG. 29 is a display example of the incorrect answer notification screen.

FIG. 30 is a display example of the hint according to a proficiency level according to the fifth embodiment.

FIG. 31 is a display example of the hint according to the proficiency level according to the fifth embodiment.

### DETAILED DESCRIPTION OF THE PREFERRED EMBODIMENTS

The embodiments of the storage medium, learning support system, and display control method of the present disclosure will be described in detail below with reference to the drawings. Various limitations that are technically preferable to implement the present disclosure are added to the embodiments described below. However, the scope of the present disclosure is not limited to the embodiments and the illustrated examples described below. In the following embodiment, the learning support system shall be used by school students and teachers. In addition, schools include not only regular elementary schools, junior high schools, high schools, and universities, but also technical schools, cram schools, and preparatory schools.

Advice information, such as hints, for a user to refer to in answering a question varies in appropriateness depending on a progress status of an answer. This disclosure addresses a problem regarding supporting a user in their learning according to the progress status in answering the question.

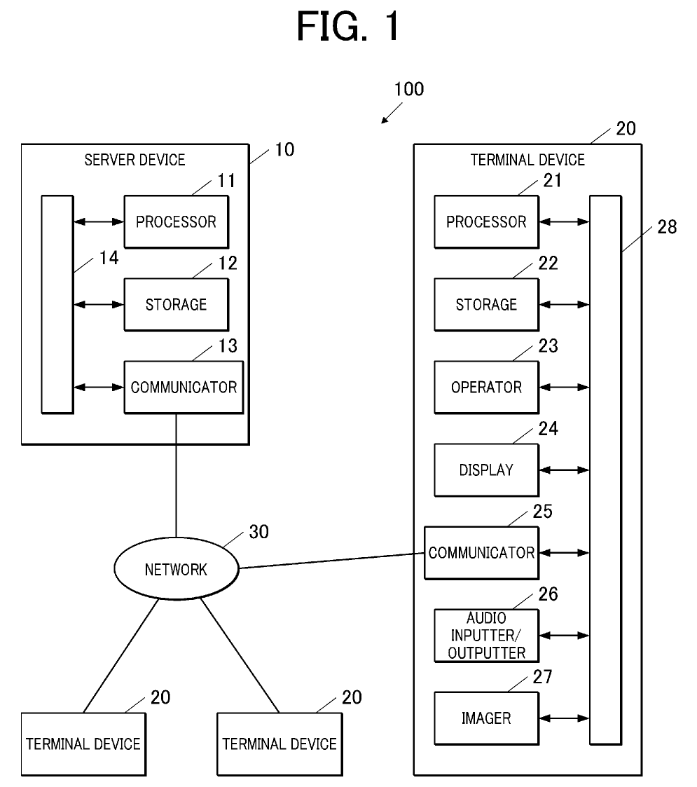

First, a first embodiment of the present disclosure is described. As shown in FIG. 1, a learning support system 100 includes a server device 10 and a plurality of terminal devices 20. The server device 10 and each terminal device 20 are connected via network 30 so as to be able to communicate data. The terminal device 20 is a terminal device used by each user (student, teacher). The terminal device 20 may be a personal computer, a tablet or other portable terminal device, a smartphone or other mobile communication device, a wearable terminal, or the like. The number of terminal devices 20 is not limited. The network 30 may be, any one or a combination of some or all of the following communication networks, for example, the Internet, a wireless LAN (Local Area Network), a wired LAN, a mobile communication network, or a short range wireless communication network.

The server device 10 (display control apparatus) includes at least one processor 11 (first processor), at least one storage 12, a communicator 13, and the like. The above structures are connected to each other via a system bus 14. The processor 11 includes a CPU (Central Processing Unit), a RAM (Random Access Memory), and the like, and controls each unit of the server device 10. Specifically, the processor 11 reads a designated program from a system program and application programs stored in the storage 12, deploys the specified program in the RAM, and executes various processes according to the program. For example, the processor 11 generates a control signal in response to an execution result of the application program to cause a display 24 of the terminal device 20 to display the execution result, and transmits the signal to the terminal device 20 via the communicator 13.

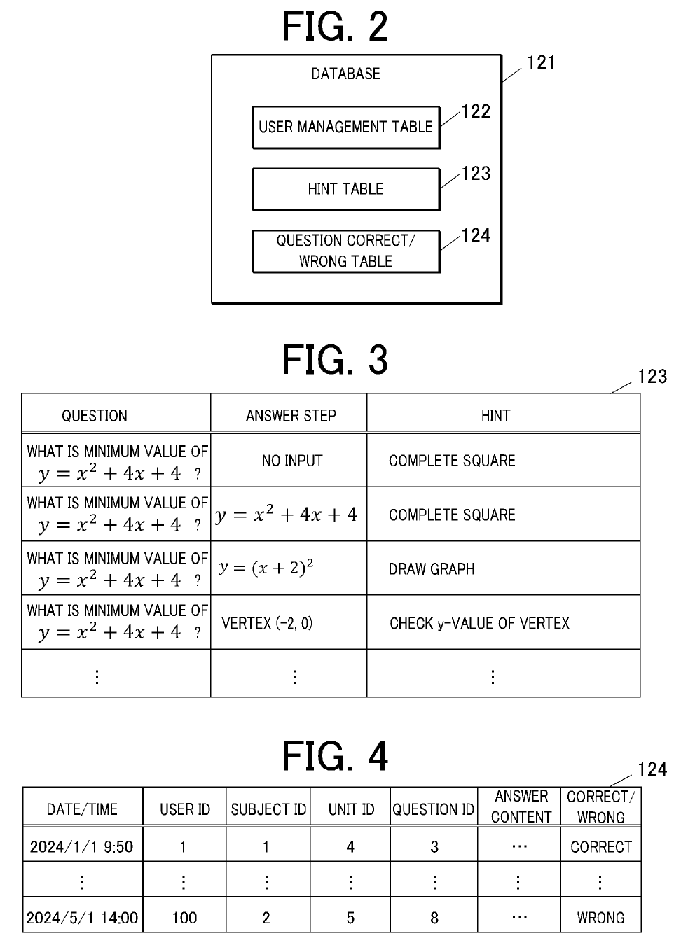

The storage 12 is a non-transitory storage medium readable by the processor 11 as a computer, and includes, for example, a HDD (Hard Disk Drive), SSD (Solid State Drive), EEPROM (Electrically Erasable Programmable Read Only Memory), etc. The storage 12 stores various programs, such as system programs and application programs, executed by the processor 11, and data required for executing the above programs. A database 121 shown in FIG. 2 is provided in a region in the storage 12. The database 121 includes a user management table 122, a hint table 123, and a question correct/wrong table 124.

The user management table 122 is a table that manages information regarding each user who uses a learning support application provided by the learning support system 100 (hereinafter referred to as "learning support application"). The user management table 122 stores information such as user ID, password, user name, gender, age, school, grade, class, region, e-mail address, and user type (student, teacher) for each user. The user ID is unique identification information assigned to each user. The password is the password registered by the user. The user name is the name of the user. The gender is the gender of the user. The age is the age of the user. The school, grade, and class are each the school, grade, and class to which the user belongs. The region can be the user's address, residence, location of the school the user belongs to, etc. The email address is the email address used by the user. The user type is information such as student, teacher, etc.

The hint table 123 is a table in which the step of the progress status of the answer is corresponded with a hint for each pre-prepared question. As shown in FIG. 3, the hint table 123 stores an answer step (calculation process showing work, that is, intermediate equations leading to a final answer) corresponded with the hint for each question. In the hint table 123, the corresponding relationship is set such that if a certain equation (or character string) is input in the calculation process, a certain hint is displayed. It is assumed that the question will be answered in a descriptive format. For example, the answer to such question will be the answer that include a mathematical formula, chemical formula, etc.

The question correct/wrong table 124 is a table that records the questions answered by each user and their correct/wrong results (correct or incorrect). As shown in FIG. 4, the question correct/wrong table 124 stores date and time, the user ID, subject ID, unit ID, question ID, answer contents, and correct/wrong corresponded to each other for each question answered by the user. The date and time is the date and time the user answered the question. The user ID is the user ID of the user who answered the question. The subject ID is identification information that indicates a subject that contains the question answered by the user. The unit ID is identification information that indicates a unit that contains the question answered by the user. The question ID is identification information that indicates the question answered by the user. The answer content is the content of the answer input by the user. The correct/wrong is information indicating whether the answer given by the user is correct or wrong (incorrect). The correct solution (correct answer) to each question is stored in the storage 12 in advance.

The communicator 13 includes a NIC (Network Interface Card) and the like, and accesses to the network 30 in order to perform electrical communication with an external device.

The processor 11 accepts the answer to the question by a learner. Specifically, the processor 11 accepts the answer to the question by the learner that is input on the operator 23 of the terminal device 20 used by the learner.

The processor 11 displays the advice information for solving the question on the display 24 of the terminal device 20 based on the progress status of the learner's input of the answer to the question for a complete answer of the question. Hereinafter, in this specification, the operation of the processor 11 displaying contents (learning materials, advice information, answer input screen, etc.) on the display 24 of the terminal device 20 includes the process of the processor 11 generating data for displaying the above advice information on the display 24 of the terminal device 20 and transmitting the generated data to the terminal device 20. The complete answer to the question includes the intermediate step (intermediate process) to obtain a final answer. The advice information includes tips, explanations, etc. The processor 11 displays the preset advice information corresponding to the step of the progress status on the display 24. For example, the processor 11 determines which hint to present to the user based on up to which part of a model answer the user's answer has been input.

When a request for advice information is input from the learner, the processor 11 displays the advice information on the display 24. For example, the processor 11 displays a button on the display 24 for requesting the advice information, and displays the advice information on the display 24 in a case in which the button is operated on the operator 23.

The terminal device 20 includes at least one processor 21 (second processor), at least one storage 22, an operator 23, a display 24, a communicator 25, an audio inputter/outputter 26, and an imager 27. The above structures are connected to each other via a system bus 28. The processor 21 includes a CPU, a RAM, etc., and controls various parts of the terminal device 20. Specifically, the processor 21 reads a designated program from a system program and application programs stored in the storage 22, deploys the specified program in the RAM, and executes various processes according to the program. For example, the processor 21 executes a learning support application program to cause information based on contents of the user's input operations on the operator 23 to be transmitted to the server device 10 by the communicator 25, or to display the information received from the server device 10 on the display 24.

The storage 22 is a non-transitory storage medium readable by the processor 21 as a computer, and is composed of, for example, HDD, SSD, EEPROM, etc. The storage 22 stores various programs, such as system programs and the learning application program, etc., executed by the processor 21, and data required for executing the above programs. The program may be downloaded from an external web server to the storage 22 via a network 30 and the communicator 25.

The operator 23 includes, for example, a keyboard, a touch screen, a mouse, and other operation inputters. The operator 23 accepts operation input by the user and outputs the operation information to the processor 21. The display 24 includes a Liquid Crystal Display (LCD), an Electro-Luminescence (EL) display, and the like, and various display is performed according to display information instructed from the processor 21. The communicator 25 includes at least one of a wired communication module such as a NIC or a wireless communication module, and accesses the network 30 to perform electrical communication with external devices.

The audio inputter/outputter 26 includes an audio inputter such as a microphone, and an audio outputter such as an amplifier and a speaker. The audio inputter/outputter 26 acquires audio signals such as a user's voice and converts the user’s voice into audio data and outputs the audio data to the processor 21 by the audio inputter. Furthermore, the audio inputter/outputter 26 outputs audio through the audio outputter based on the audio data input from the processor 21. The imager 27 is a digital camera including an optical system and an imaging element such as CCD (Charge Coupled Device), CMOS (Complementary Metal Oxide Semiconductor), etc. The imager 27 captures an image of a subject and generates still and moving image data to be output to the processor 21.

Next, the operation of the learning support system 100 will be described. First, the user starts the learning support application on the terminal device 20 by operating from the operator 23, and inputs the user ID and password. The processor 11 of the server device 10 refers to the user management table 122 and allows the user of the terminal device 20 to log in if there is data that matches the combination of information input from the terminal device 20.

The processor 11 displays on the display 24 a list of learning materials for learning. The list of learning materials for learning displays learning materials for each unit of the subjects. The processor 11 accepts the user's operation of selecting learning materials from the terminal device 20. When the user selects one of the learning materials in the list region of learning materials for learning by operating from the operator 23, the processor 11 displays the selected learning material (subject or unit) on the display 24. The learning materials include a plurality of questions according to the unit. The user (learner) uses the terminal device 20 to study each unit of each subject, and inputs the answer to each question through the operation from the operator 23. For example, the user solves the question on a tablet terminal using an electronic pen.

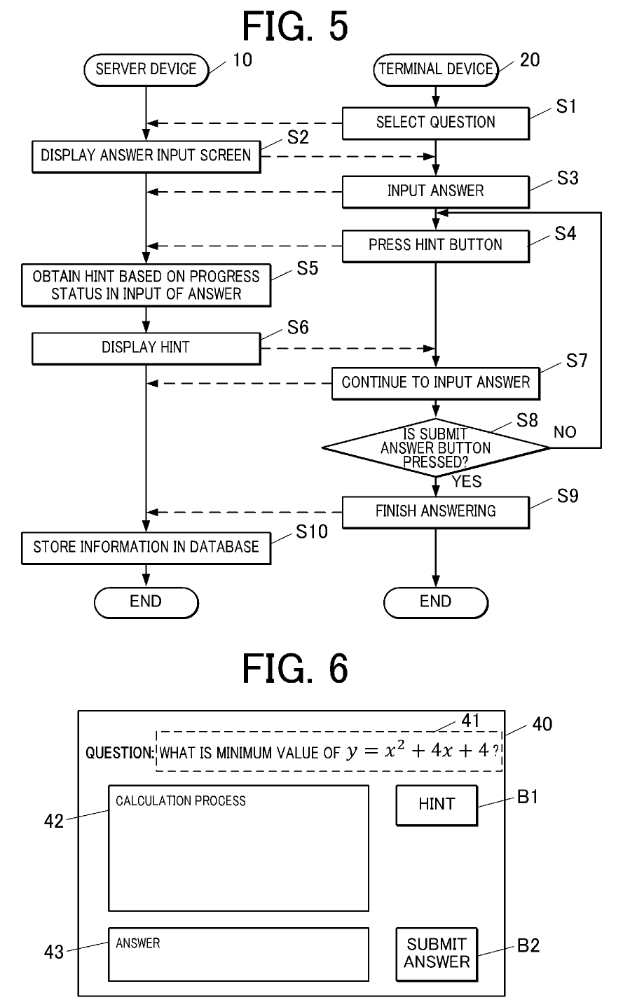

Referring to FIG. 5, the learning support process executed in the learning support system 100 is described. The processor 11 displays a question selection screen on the display 24. The question selection screen displays a plurality of questions related to the subject and the unit to be studied, which can be selected. The processor 21 transmits information indicating the question selected from the plurality of questions displayed on the question selection screen by user operation from the operator 23 to the server device 10 via the communicator 25 (step S1). The processor 11 obtains information indicating the selected question from the terminal device 20 via the communicator 13.

Next, the processor 11 displays the answer input screen for the selected question on the display 24 (step S2). For example, as shown in FIG. 6, the answer input screen 40 includes a question display field 41, a calculation process input field 42, a final answer field 43, a hint button B1, and a submit answer button B2. The question is displayed in the question display field 41. The calculation process input field 42 is a region for inputting the calculation process. The final answer field 43 is a region for inputting the final answer. The hint button B1 is a button used for requesting the hint. The submit answer button B2 is a button used for completing the answer and submitting the answer.

Next, the user inputs the answer to the answer input screen 40 displayed on the display 24 by operating the operator 23, and the processor 21 transmits the answer accepted by input to the server device 10 (step S3). The processor 11 accepts input of the answer from the terminal device 20.

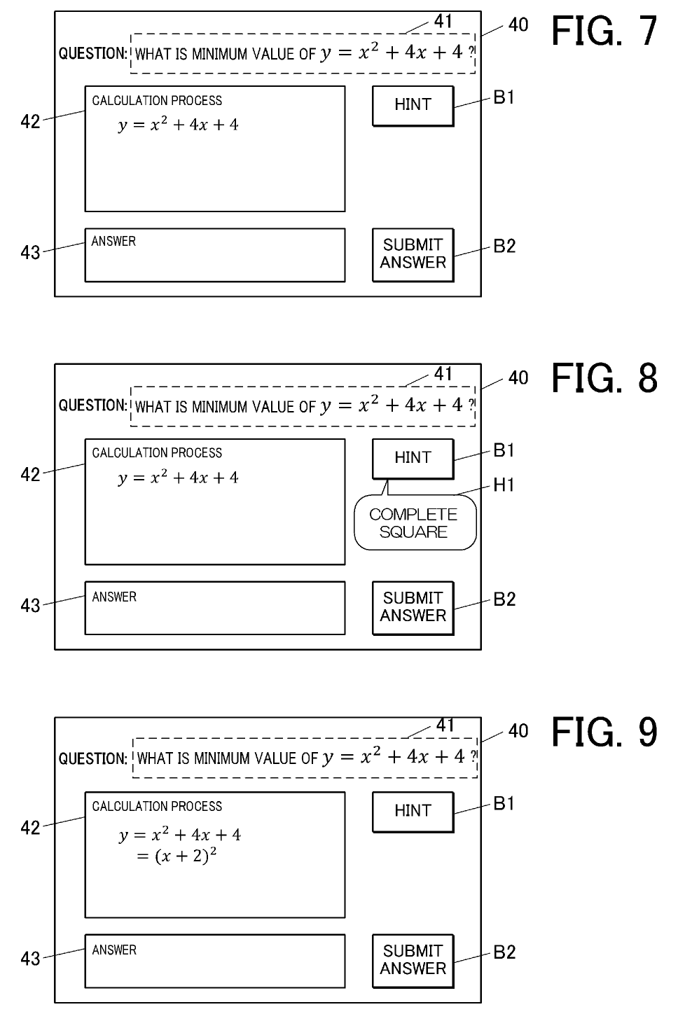

If necessary, the user presses the hint button B1 on the terminal device 20 by operating the operator 23. The processor 21 accepts a press operation to the hint button B1 via the operator 23 (step S4). When the processor 11 determines that pressing of the hint button B1 has been accepted at the terminal device 20, the processor 11 obtains the hint from the hint table 123 based on the progress status of the input of the answer (step S5). Specifically, the processor 11 identifies from the hint table 123 the answer step that matches the contents of the calculation process input by the user, and obtains the hint corresponding to the identified answer step as the hint to be presented. The processor 11 displays the obtained hint on the display 24 (step S6). For example, if the hint button B1 is pressed while the equation of the question statement is input in the calculation process input field 42, as in the answer input screen 40 shown in FIG. 7, the hint H1, "Complete square," will be displayed, as in the answer input screen 40 shown in FIG. 8. Here, the hint H1 appears in the form of a speech bubble starting with the hint button B1, but the hint may also be displayed as a pop-up screen.

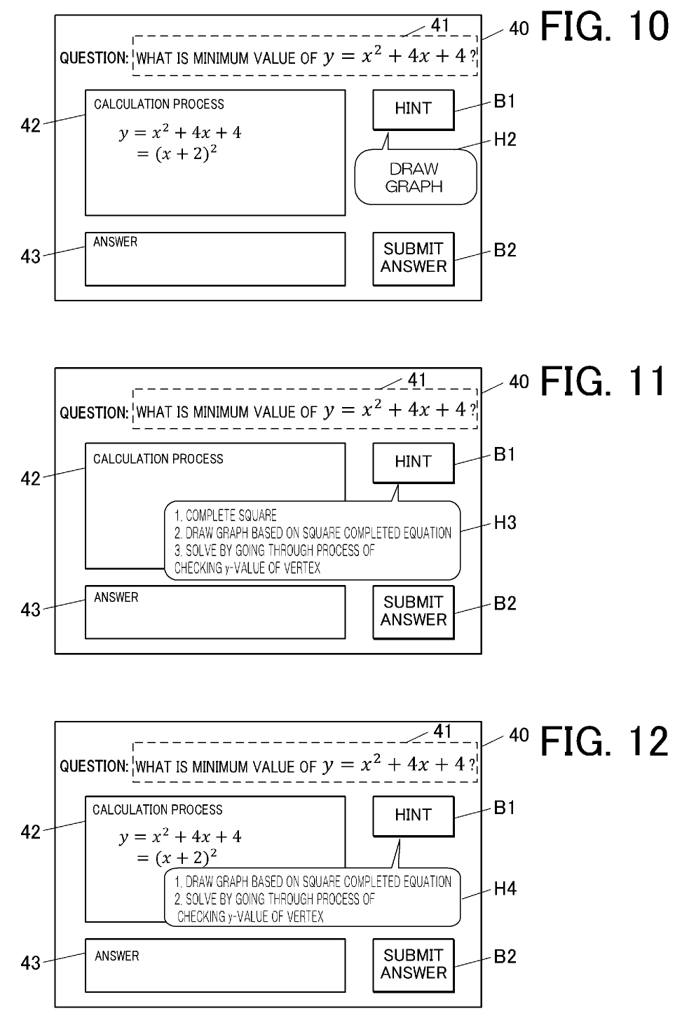

The user continues to input the answer to the answer input screen 40 displayed on the display 24 by operating the operator 23, and the processor 21 transmits the answer accepted by input to the server device 10 (step S7). The processor 11 accepts the input of the answer from the terminal device 20. If the submit answer button B2 is not pressed in the terminal device 20 by operation from the operator 23 (step S8; NO), the process returns to step S4. For example, if the hint button B1 is pressed while a square completed equation is input in the calculation process input field 42, as in the answer input screen 40 shown in FIG. 9, the hint H2, "Draw graph," will be displayed, as in the answer input screen 40 shown in FIG. 10.

In a case in which the submit answer button B2 is pressed in step S8 (step S8; YES), the answer is completed on the terminal device 20 (step S9). The processor 11 stores the information in the database 121 (step S10). For a question answered by the user (learner), the processor 11 stores the following in the question correct/wrong table 124 corresponded to each other, the date and time the user answered the question, the user's user ID, the subject ID of the subject containing the question, the unit ID of the unit containing the question, the question ID of the question, the content of the answer, and whether the answer of the question is correct or wrong. This concludes the learning support process.

As described above, according to the first embodiment, the processor 11 performs display control to display the advice information for solving the question on the display 24 based on the progress status of the learner's input of the answer to the question. Therefore, according to the processor 11, it is possible to display the advice information in accordance with the progress status of the answer to the question, thereby supporting the user's learning. The user can receive appropriate hints that match the user's own progress status of the answer to the question.

The processor 11 also displays the predefined advice information corresponding to the step of the progress status on the display 24. For example, the processor 11 can refer to the hint table 123 to provide hints appropriate to the progress status of the answer.

When a request for the advice information is input by the learner, such as by pressing the hint button B1, the processor 11 displays the advice information on the display 24. The processor 11 can display the advice information at the timing requested by the user without disturbing the user's concentration.

Next, modification example 1 of the first embodiment will be described. In modification example 1, only the units that differ from the first embodiment will be described. The processor 11 controls the display 24 to display the advice information with less information as the progress status becomes closer to the complete answer of the problem. For example, in the storage 12, for each question, the information is prepared in advance indicating multiple processes, including the process leading up to the correct answer. This information may be stored in the same format as the hint table 123. The closer the progress status of the input of the answer is to the complete answer, the processor 11 displays the hint omitting more of the description corresponding to the contents of the already inputted calculation process. As a result, the closer the progress status of the input of the answer is to the complete answer, the less information the hint provides.

For example, if the hint button B1 is pressed when no calculation process is input in the calculation process input field 42, as in the answer input screen 40 shown in FIG. 6, the hint H3 including all the steps to the correct answer is displayed, as in the answer input screen 40 shown in FIG. 11. On the other hand, if the hint button B1 is pressed while a square completed equation is input in the calculation process input field 42, as in the answer input screen 40 shown in FIG. 9, the hint H4 is displayed, excluding the process corresponding to the square completion, among the processes leading to the correct answer, as in the answer input screen 40 shown in FIG. 12.

According to modification example 1, the closer the progress status is to the complete answer to the question, the processor 11 displays less informative advice information on the display 24. Therefore, according to the processor 11, it is possible to avoid presenting too much advice information when the user's answer is progressing smoothly, and this contributes to improving the user's learning ability.

Next, modification example 2 of the above embodiment will be described. In modification example 2, only the units that differ from the first embodiment will be described. If the hint button B1 is pressed while no calculation process is input, the processor 11 allows the user to select the current situation. The storage 12 includes a pre-prepared set of candidate options for the calculation process for each question. The user selects the current situation depending on up to which step of the process the user is thinking about. The processor 11 displays a hint corresponding to the selected current situation.

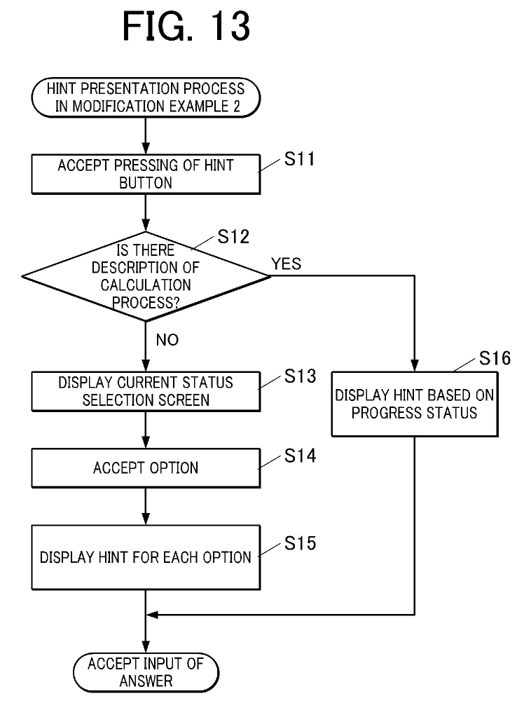

Referring to FIG. 13, the hint presentation process in modification example 2 performed in the server device 10 is described. The hint presentation process in modification example 2 is performed in place of the steps S4 through S6 of the learning support process (see FIG. 5). When the processor 11 accepts pressing of the hint button B1 from the operator 23 (step S11), the processor 11 determines whether or not there is a description of the calculation process in the calculation process input field 42 on the answer input screen 40 (step S12).

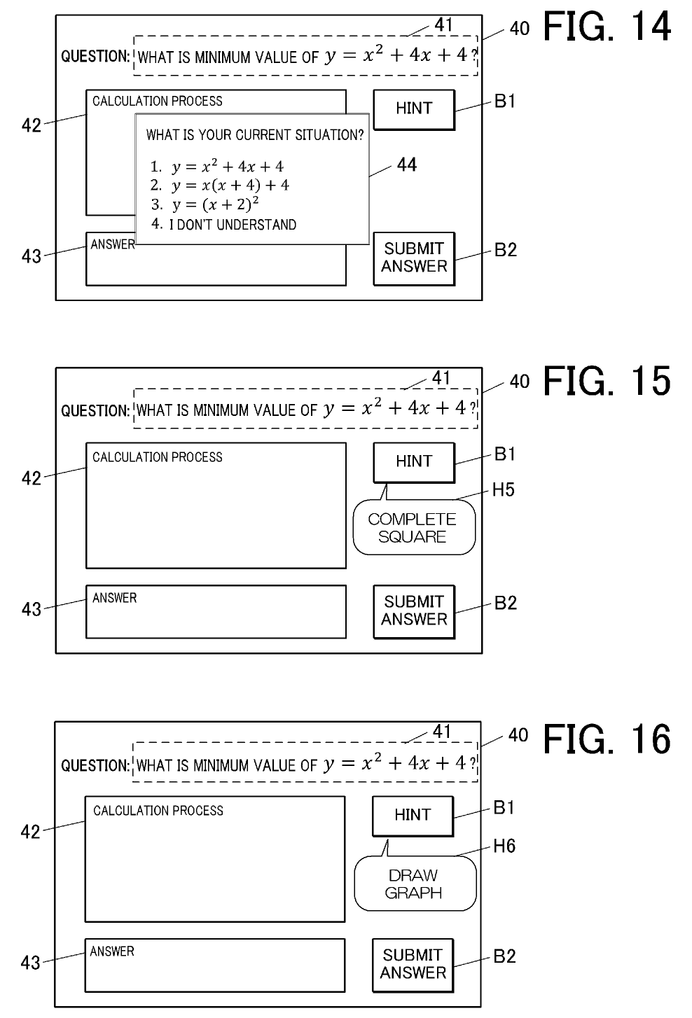

In a case in which it is determined that there is no description of the calculation process (step S12; NO), the processor 11 displays the current status selection screen on the display 24 (step S13). For example, as shown in FIG. 14, the current status selection screen 44 is superimposed on the answer input screen 40 and displayed. The current status selection screen 44 allows the user to select the current status from among four options. Option 1 is the equation as stated in the question statement. Option 2 is part of the equation being bracketed. Note that Option 2 is not part of the process leading to the correct solution, but is listed as one of the possible calculation processes that the user may consider. Option 3 is the square completed state equation. Option 4 is selected when the user does not know how to solve the question.

When the processor 11 accepts the selection of the option (calculation process, etc.) from the operator 23 (step S14), the processor 11 displays the hint on the display 24 according to the selected option (step S15). For example, the processor 11 obtains the hint corresponding to the content of the options from the hint table 123. Alternatively, the processor 11 may obtain hints that are associated in advance with each option. For example, in a case in which one of the options 1, 2, or 4 is selected on the current status selection screen 44 shown in FIG. 14, the hint H5, "Complete square," corresponding to the initial step, will be displayed, as shown in the answer input screen 40 shown in FIG. 15. In a case in which option 3 is selected on the current status selection screen 44 shown in FIG. 14, the hint H6, "Draw graph" corresponding to the square completed equation, is displayed, as shown in the answer input screen 40 shown in FIG. 16.

In a case in which it is determined in step S12 that there is the description of the calculation process (step S12; YES), the processor 11 displays the hint on the display 24 according to the progress status of the input of the answer (step S16), as in the first embodiment. After step S15 or step S16, the processor 11 accepts input of the answer from the operator 23.

According to modification example 2, the processor 11 presents the candidate option of the calculation process and allows the user to select the current status. With this, according to the processor 11, it is possible to understand the progress status of the user's answers even when no calculation processes have been input on the answer input screen 40, and to support the user's learning in accordance with the progress status of the answer to the question.

Next, the modification example 3 of the first embodiment will be described. In modification example 3, only the parts that differ from the first embodiment will be described. The processor 11 disables the acceptance of a request for the advice information from the learner in a case in which the progress status of inputting the answer is in a predetermined status. Here, the case in which the "predetermined status" is "a status where square completion has not been performed in the calculation process" is shown as an example. In other words, the processor 11 can accept the request for the advice information on the condition that a square completed equation is input in the calculation process.

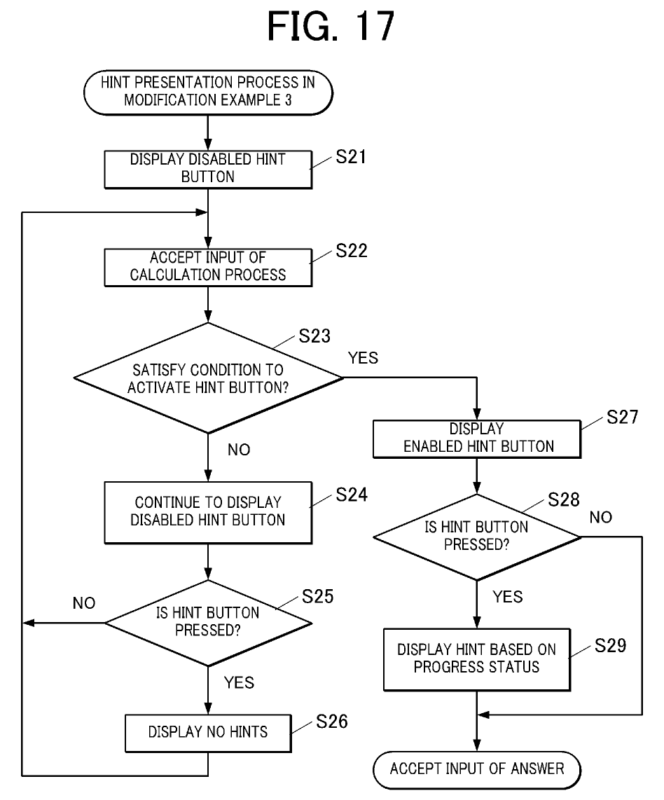

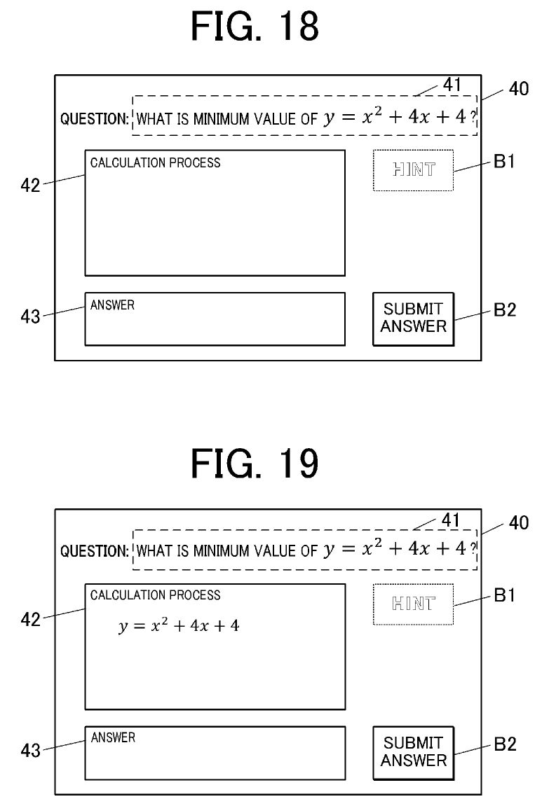

Referring to FIG. 17, the hint presentation process in modification example 3 performed in the server device 10 is described. The hint presentation process in modification example 3 is performed in place of steps S3 through S6 of the learning support process (see FIG. 5). In displaying the answer input screen 40 for the question on the display 24, the processor 11 initially displays the hint button B1 in a disabled state (step S21). The hint button B1 being disabled means that the request for the hint (advice information) cannot be accepted. Methods to disable the hint button B1 include, preventing the user from pressing the hint button B1, or preventing the hint from being displayed even if the hint button B1 is pressed. For example, if the hint button B1 is disabled, the hint button B1 is displayed with a dashed line and white text, as in the answer input screen 40 shown in FIG. 18. In a case in which the hint button B1 is disabled, the hint button B1 may be displayed in a light color, etc.

Next, the processor 11 accepts the input of the calculation process for the answer from the operator 23 (step S22). The processor 11 determines whether or not the input calculation process meets the conditions for activation of the hint button B1 (step S23). For example, the processor 11 determines whether or not the input calculation process contains a square completed equation. In a case in which it is determined that the input calculation process does not meet the conditions for activation of the hint button B1 (step S23; NO), the processor 11 continues the disabled display of the hint button B1 (step S24). For example, in the answer input screen 40 shown in FIG. 19, the hint button B1 remains disabled because the equation input in the calculation process input field 42 is not completed in square.

Next, the processor 11 determines whether the hint button B1 is pressed on the terminal device 20 (step S25). In a case in which it is determined that the hint button B1 is pressed (step S25; YES), the processor 11 does not display the hint on the display 24 (step S26). In other words, even if the hint button B1 is pressed on the answer input screen 40 shown in FIG. 19, no hint appears. In a case in which it is determined in step S25 that the hint button B1 is not pressed (step S25; NO) or after step S26, the processor 11 returns the process to step S22.

In a case in which it is determined in step S23 that the condition for enabling the hint button B1 is met (step S23; YES), the processor 11 enables the hint button B1 on the answer input screen 40 and displays the above on the display 24 (step S27). When the hint button B1 is enabled, this means that the request for the hint (advice information) can be accepted. When the hint button B1 is enabled, the hint will appear by pressing the hint button B1. For example, as shown in FIG. 9, in a case in which a square completed equation in the calculation process is input in the calculation process input field 42 of the answer input screen 40, the hint button B1 is displayed as usual.

Next, the processor 11 determines whether the hint button B1 is pressed on the terminal device 20 (step S28). In a case in which it is determined that the hint button B1 is pressed (step S28; YES), the processor 11 displays the hint on the display 24 according to the progress status of the input of the answer (step S29). For example, if the hint button B1 is pressed while a square completed equation in a calculation process is input in the calculation process input field 42, as in the answer input screen 40 shown in FIG. 9, the hint H2, "Draw graph," corresponding to the square completed equation is displayed as shown in the answer input screen 40 in FIG. 10. In a case in which it is determined in step S28 that the hint button B1 is not pressed (step S28; NO), or after step S29, the processor 11 accepts the input of the answer from the operator 23.

According to modification example 3, the processor 11 disables the acceptance of the request for the advice information from the learner in a case in which the progress status of inputting the answer is in a predetermined status. For example, the processor 11 disables the hint button B1 until the user's progress status in inputting the answer reaches a predetermined step, and enables the hint button B1 on the condition that the predetermined step is reached. This allows the user to solve the question on their own up to a certain step, and to avoid needlessly referring to the advice information.

Next, the second embodiment to which this disclosure is applied is described. Since the learning support system in the second embodiment has the same configuration as the learning support system 100 shown in the first embodiment, only the units that differ from the first embodiment will be described.

According to the second embodiment, in a case in which the course (direction) of the answer heads toward a different direction from the correct solution (model answer), the user is prompted to revise the course. The processor 11 determines whether the answer matches the correct solution. In a case in which the processor 11 determines that the answer does not match the correct solution, the processor 11 displays on the display 24 the information that encourages the user to reconsider the answer as the advice information. In other words, the processor 11 displays the hint at the point when the processor 11 determines that the course of the input answer is wrong, regardless of whether the hint button B1 is pressed.

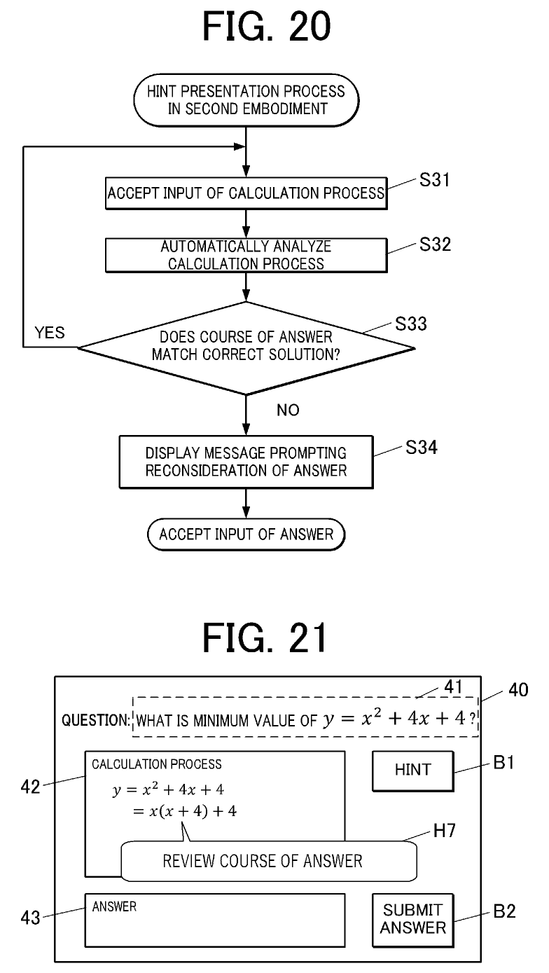

Referring to FIG. 20, the hint presentation process of the second embodiment performed in the server device 10 is described. The hint presentation process according to the second embodiment is performed in place of or performed parallel with steps S3 through S6 of the learning support process (see FIG. 5). When the processor 11 accepts the input of the calculation process from the operator 23 (step S31), the processor 11 automatically analyzes the input calculation process (step S32). The processor 11 recognizes characters, numbers, symbols, etc. input at the terminal device 20. Based on the analyzed result, the processor 11 determines whether the course of the answer matches the correct solution (step S33). For example, the processor 11 determines whether the input calculation process follows the progression of the answer steps stored in the hint table 123 (i.e., whether the calculation process matches each answer step stored in the hint table 123).

In a case in which the course of the answer is determined to match the correct solution (step S33; YES), the processor 11 returns the process to step S31. For example, in the answer input screen 40 shown in FIG. 7, the equation input in the calculation process input field 42 matches the equation in the question statement and is not different from the correct solution process, so the input of the answer continues as is.

On the other hand, in a case in which it is determined in step S33 that the course of the answer does not match the correct solution (step S33; NO), the processor 11 displays on the display 24 the message urging the user to reconsider the answer (step S34). For example, in the answer input screen 40 shown in FIG. 21, the equation input in the calculation process input field 42 is different from the correct solution process, so the hint H7 is displayed, "Review course of answer”. Here, the processor 11 may display the hint H7 by clearly indicating where the answer is considered to be misdirected. After step S34, the processor 11 accepts the input of the answer from the operator 23.

As explained above, according to the second embodiment, in a case in which the processor 11 determines that the answer does not match the correct solution, the processor 11 displays on the display 24 the information that encourages the user to reconsider the answer as the advice information. In a case in which the user's course of the answer is different from the correct solution, the processor 11 displays the information that encourages the user to reconsider the solution. With this, it is possible to prevent the user from wasting time with the incorrect course and to guide the user to the correct solution. Thus, the processor 11 can assist the user in learning according to the user’s progress status in answering the question.

Next, the third embodiment to which this disclosure is applied is described. Since the learning support system in the third embodiment has the same configuration as the learning support system 100 shown in the first embodiment, only the units that differ from the first embodiment will be described.

According to the third embodiment, the processor 11 displays the advice information on the display 24 in a case in which no answer is input by the learner for a predetermined amount of time or longer. In other words, the processor 11 displays the hint when the predetermined amount of time has elapsed without any input, regardless of the pressing of the hint button B1.

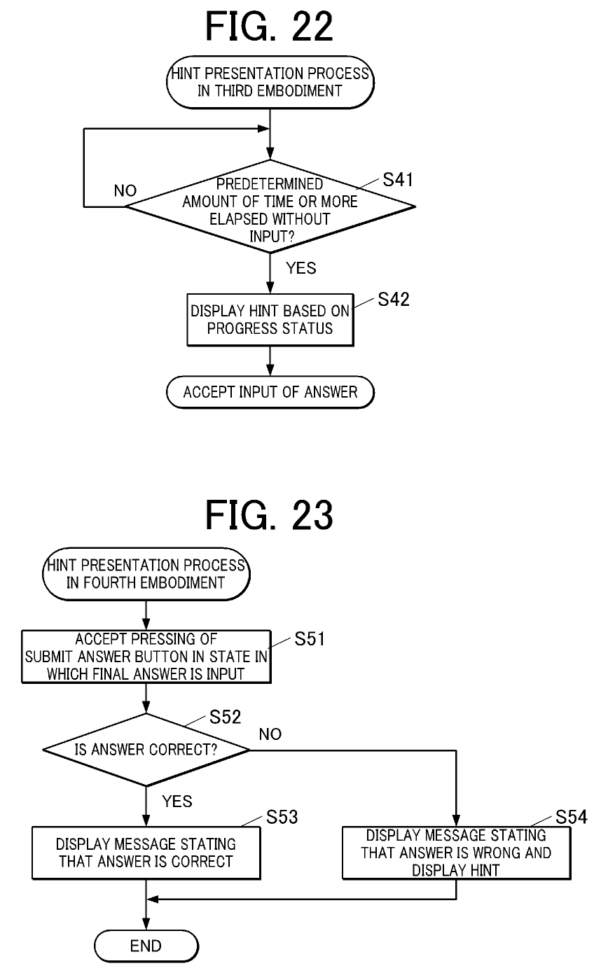

Referring to FIG. 22, the hint presentation process of the third embodiment performed in the server device 10 is described. The hint presentation process according to the third embodiment is performed parallel with steps S3 through S6 of the learning support process (see FIG. 5). The processor 11 determines whether the predetermined amount of time or more has elapsed without any input from the operator 23 (step S41). In a case in which it is determined that the predetermined amount of time or more has not elapsed without input (step S41; NO), the processor 11 returns the process to step S41.

In a case in which it is determined in step S41 that a predetermined amount of time or more has elapsed without any input (step S41; YES), the processor 11 displays the hint on the display 24 according to the progress status of the input of the answer (step S42). For example, as shown in the answer input screen 40 shown in FIG. 15, when a predetermined amount of time or more has elapsed without any input in the calculation process input field 42, the hint H5 is displayed, "Complete square”. In a case in which something has been input in the calculation process input field 42, but a predetermined amount of time or more has elapsed without any new input, the hint is displayed according to the progress status of the input of the answer. After step S42, the processor 11 accepts the input of the answer from the operator 23.

As described above, according to the third embodiment, the processor 11 displays the advice information on the display 24 in a case in which no answer is input by the learner for a predetermined amount of time or more. In a case in which no answer is input for a predetermined amount of time, it is assumed that the user is stuck on the answer. Therefore, according to the processor 11, it is possible to display the advice information in accordance with the progress status of the answer to the question, thereby supporting the user's learning.

Next, the fourth embodiment to which this disclosure is applied is described. Since the learning support system in the fourth embodiment has the same configuration as the learning support system 100 shown in the first embodiment, only the units that differ from the first embodiment will be described.

The fourth embodiment describes the display control in a case in which the final answer is the correct answer or the incorrect answer, regardless of whether the calculation process is input or not. The processor 11 displays the advice information on the display 24 in a case in which the answer by the learner is the incorrect answer. The processor 11 displays the advice information on the display 24 in a case in which the answer by the learner is the correct answer but the information indicating the progress status toward the answer does not match the predetermined content (a case in which the calculation process does not match each answer step stored in the hint table 123). For example, “the information indicating the progress status toward the answer does not match the predetermined content” includes the following cases, there is no input of the equations in the calculation process, a formula which the user has not learned yet is used, a formula for development is not used and the user develops the answer by himself, etc.

Referring to FIG. 23, the hint presentation process of the fourth embodiment performed in the server device 10 is described. The hint presentation process according to the fourth embodiment is performed at the time of answer submission in step S8 of the learning support process (see FIG. 5). When the processor 11 accepts pressing of the submit answer button B2 from the operator 23 with the final answer input in the final answer field 43 on the answer input screen 40 (step S51), the process advances to step S52. In step S52, the processor 11 determines whether the final answer input in the final answer field 43 is the correct answer or not.

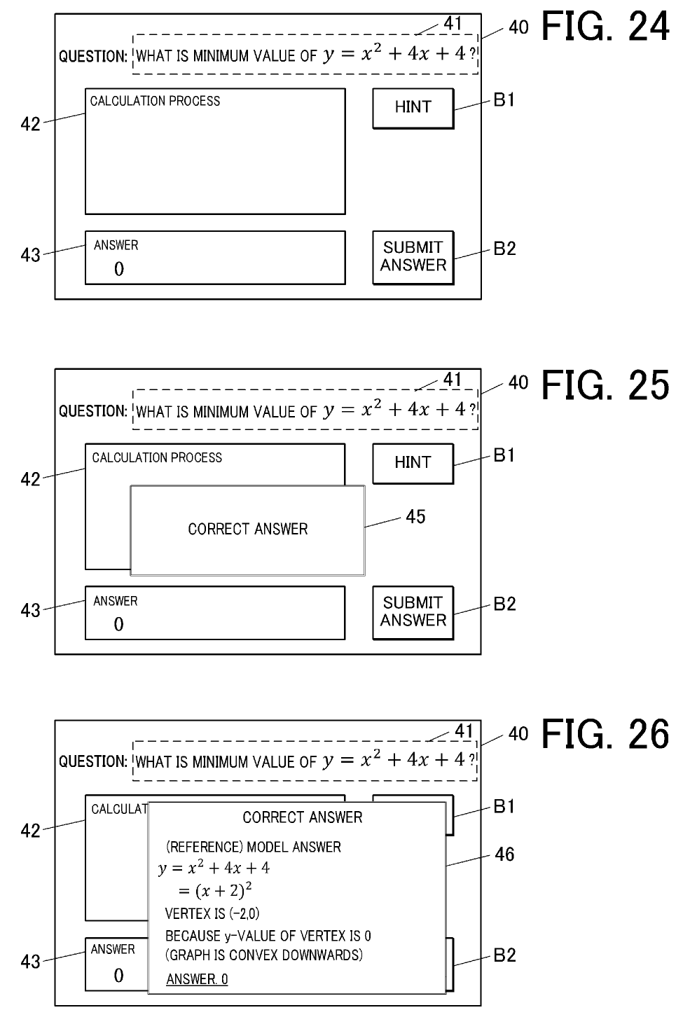

In a case in which the final answer is determined to be the correct answer (step S52; YES), the processor 11 displays the message on the display 24 stating that the answer is the correct answer (step S53). For example, as in the answer input screen 40 shown in FIG. 24, there is no input in the calculation process input field 42 and "0" is input as the answer in the final answer field 43 (correct answer). In this state, when the submit answer button B2 is pressed, a correct answer notification screen 45 including a message showing that the answer is correct is displayed, as in the answer input screen 40 shown in FIG. 25. Alternatively, in a case in which the submit answer button B2 is pressed in the state shown in FIG. 24, a correct answer notification screen 46 including a message showing the answer is the correct answer and a model answer may be displayed, as in the answer input screen 40 shown in FIG. 26.

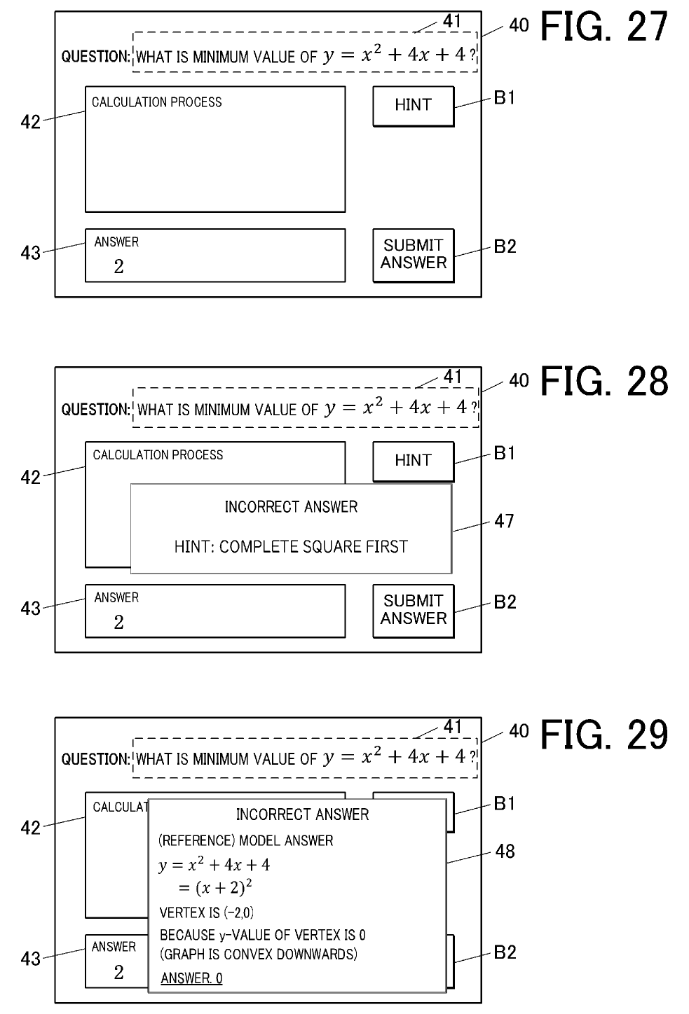

In a case in which it is determined in step S52 that the final answer is not the correct answer (step S52; NO), the processor 11 displays the message that the answer is the incorrect answer and the hint on the display 24 (step S54). For example, as in the answer input screen 40 shown in FIG. 27, there is no input in the calculation process input field 42 and "2" is input as the answer in the final answer field 43 (incorrect answer). In this state, when the submit answer button B2 is pressed, an incorrect answer notification screen 47 including a message showing that the answer is incorrect and the hint is displayed, as in the answer input screen 40 shown in FIG. 28. For example, the hint corresponding to the initial step is displayed. Alternatively, in a case in which the submit answer button B2 is pressed in the state shown in FIG. 27, an incorrect answer notification screen 48 including a message showing the answer is the incorrect answer and a model answer may be displayed, as in the answer input screen 40 shown in FIG. 29. After step S53 or step S54, the hint presentation process according to the fourth embodiment ends.

As described above, according to the fourth embodiment, the processor 11 displays the advice information on the display 24 in a case in which the answer accepted from the terminal device 20 is the incorrect answer. For example, according to the processor 11, it is possible to display the hint corresponding to the initial step or the model answer. Therefore, it is possible to present the correct answer to the user. In a case in which the accepted answer is the correct answer, but the information indicating the progress toward the answer does not match the predetermined content, the processor 11 displays the advice information on the display 24. For example, the processor 11 can display the model answer so that the user can check the correct procedure for solving the question.

Next, the fifth embodiment to which this disclosure is applied is described. Since the learning support system according to the fifth embodiment has the same configuration as the learning support system 100 shown in the first embodiment, only the units that differ from the first embodiment will be described.

According to the fifth embodiment, the processor 11 displays the advice information on the display 24 based on the progress status of the input of the answer and a proficiency level of the learner. For example, the processor 11 changes the details of the hints presented to the user based on the learner's proficiency level. The proficiency level is information that indicates the degree of understanding of the subject matter (subject, unit, etc.) and the ability to solve the questions. The processor 11 uses a technique called knowledge tracing ("Deep Knowledge Tracing", Chris Piech et al, Advances in Neural Information Processing Systems, 2015,. 28, 505-513) to calculate the proficiency level of each unit at each time of day (term including the above) based on the user's history of correct and incorrect questions. Let x[t, u, s] be the proficiency level at time t, user u, and unit s. The processor 11 estimates the current proficiency level based on the correct/incorrect history of the questions in the same unit s as the unit (e.g., quadratic functions) in which the user u is currently working on the question.

The processor 11 calculates the user u's current (time t1) proficiency level x[t1, u, s] in the unit s using knowledge tracing from the user u's correct/incorrect history stored in the question correct/wrong table 124. As the proficiency level, for example, a correct answer rate to questions in the target unit s during a predetermined period of time including each time may be used. In this case, the correct answer rate is the ratio of the number of questions answered correctly by the user to the total number of questions, and the predetermined period may be set freely, such as one day, one week, or one month. In a case in which the target unit s is "quadratic functions," the processor 11 may acquire the proficiency level for the subject as a whole, including not only "quadratic functions" but also "statistics," "trigonometric functions," etc., which are other areas in the same subject. The proficiency level is not limited to those calculated using knowledge tracing or using the learner's past correct answer rate.

According to the fifth embodiment, the process of step S5 in the learning support process shown in FIG. 5 is different. When the processor 11 accepts pressing of the hint button B1 from the operator 23 instead of step S5, the processor 11 obtains the hint from the hint table 123 based on the progress status of the input of the answer and the learner's proficiency level. The hint table 123 used here is the table in which the hints to be presented are associated to the combination of the progress status of the input of the answer and the learner's proficiency level.

For example, in a case in which the learner's proficiency level is the threshold value a or more, as shown in the answer input screen 40 shown in FIG. 15, when the hint button B1 is pressed while nothing is input in the calculation process input field 42, the hint H5, "Complete square," is displayed. The hint H5 is a relatively simple hint, so the learner needs to have a certain degree of understanding regarding the contents of what the learner is learning.

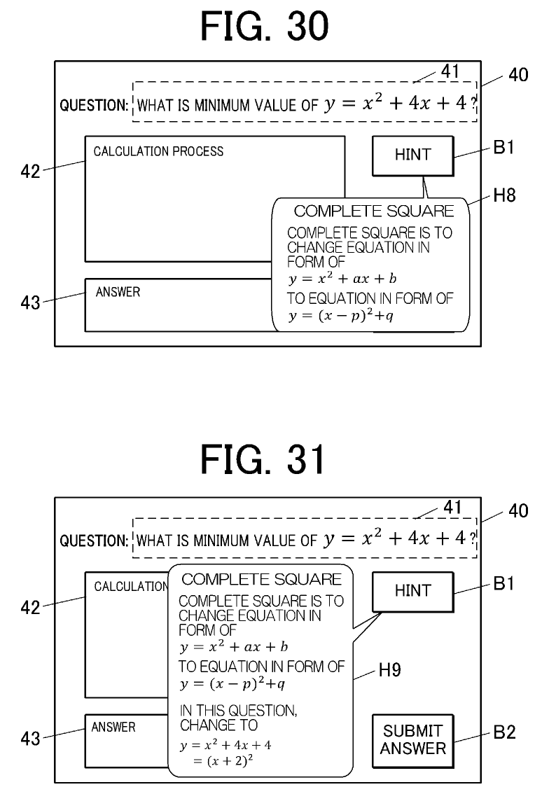

In a case in which the learner's proficiency level is less than the threshold value a and equal to or greater than the threshold value b (b < a), as shown in the answer input screen 40 shown in FIG. 30, when the hint button B1 is pressed while nothing is input in the calculation process input field 42, the message "Complete square," as well as the hint H8 including the formula for completing the square is displayed. Here, the learner is expected to be proficient enough to solve the question by using the formula for completing the square as a clue.

In a case in which the learner's proficiency level is less than the threshold value b, as in the answer input screen 40 shown in FIG. 31, when the hint button B1 is pressed while nothing is input in the calculation process input field 42, in addition to the message "Complete square" and the formula for completing the square, the hint H9 including the example in which the numeric value corresponding to this question substituted into the formula is displayed. This learner is considered to need more advice than the learner whose proficiency level is below the threshold value a and equal to or above the threshold value b.

As explained above, according to the fifth embodiment, the processor 11 displays the advice information on the display 24 based on the progress status of the input of the answer and the learner's proficiency level. The processor 11 can present more appropriate advice information by considering the learner's proficiency level. Therefore, according to the processor 11, it is possible to display the advice information in accordance with the progress status of the answer to the question, thereby supporting the user's learning.

The descriptions in the above embodiments and modification example are examples of the storage medium, learning support system, and display control method for the present disclosure, and are not limited thereto. The detailed configurations, components and operations of the components constituting the system can also be appropriately modified within the scope of the present disclosure. For example, each configuration or each process described in each of the above embodiments and modification examples may be combined as appropriate. The storage medium, learning support system, and display control method of the present disclosure can also reliably support the user in performing technical tasks (i.e., presenting hints appropriate to the progress status of the answer) by means of a user-machine interaction process. For example, as the user-machine interaction process, the display control apparatus of the present disclosure has a function to accept the input of the answers to the question, as well as the function to present the advice information (hints) suitable for the progress status of the input of the answer. Thus, the user is reliably assisted in answering the question and in learning the area (unit, subject) pertaining to the question.

In each of the above embodiments and modification example, the processor 11 of the server device 10 is configured to control the content displayed on the display 24 of the terminal device 20 in response to operations from the operator 23 of the terminal device 20. Alternatively, the display control apparatus may include an operator and a display, and the display control apparatus alone (stand-alone) may be used for processing.

The above examples are not limited to computer-readable media that store programs for executing each process. As the medium providing the data of the program through communication lines, a carrier wave can be applied.

What is claimed is:

1. A non-transitory computer-readable storage medium storing a computer program readable by a computer of a display control apparatus, wherein the program executed by the computer causes the display control apparatus to:
based on a progress status of an input of an answer to a question by a learner with relation to a complete answer to the question, generate data for displaying on a display advice information used for solving the question.

2. The storage medium according to claim 1, wherein, in a case in which a request for the advice information is input from the learner, the program causes the display control apparatus to generate the data for displaying on the display the advice information.

3. The storage medium according to claim 2, wherein, in a case in which the progress status is in a predetermined status, the program causes the display control apparatus to not allow a request for the advice information from the learner to be acceptable.

4. The storage medium according to claim 1, wherein the program causes the display control apparatus to generate the data for displaying on the display the advice information which is preset corresponding to a step of the progress status.

5. The storage medium according to claim 1, wherein the program causes the display control apparatus to generate the data for displaying on the display the advice information with less amount of information as the progress status becomes closer to the complete answer to the question.

6. The storage medium according to claim 1, wherein, in a case in which it is determined whether the answer matches a correct solution and it is determined that the answer does not match the correct solution, the program causes the display control apparatus to generate the data for displaying on the display information urging reconsideration of the answer as the advice information.

7. The storage medium according to claim 1, wherein, in a case in which the answer by the learner is not input for a predetermined amount of time or more, the program causes the display control apparatus to generate the data for displaying on the display the advice information.

8. The storage medium according to claim 1, wherein, in a case in which the answer is an incorrect answer, or in a case in which the answer is a correct answer but information indicating a process leading up to the answer does not match a predetermined content, the program causes the display control apparatus to generate the data for displaying on the display the advice information.

9. A learning support system comprising:
a display control apparatus including a first processor; and
a terminal device including a display, an operator, and a second processor,
wherein,
the display control apparatus is connected to the terminal apparatus, and the display control apparatus and the terminal apparatus are able to communicate data,
the second processor of the terminal device accepts an answer to a question from a learner, wherein the answer is input from the operator of the terminal apparatus used by the learner,
the second processor transmits the answer to the display control apparatus,
the first processor of the display control apparatus generates data for displaying on the display advice information used for solving the question based on a progress status of an input of the answer obtained from the terminal device with relation to a complete answer to the question, and transmits the data to the terminal device, and
the second processor of the terminal device displays on the display the advice information based on the data obtained from the display control apparatus.

10. The learning support system according to claim 9, wherein, in a case in which a request for the advice information is input from the learner, the first processor of the display control apparatus generates the data for displaying on the display the advice information.

11. The learning support system according to claim 10, wherein, in a case in which the progress status is in a predetermined status, the first processor of the display control apparatus does not allow a request for the advice information from the learner to be acceptable.

12. The learning support system according to claim 9, wherein the first processor of the display control apparatus generates the data for displaying on the display the advice information with less amount of information as the progress status becomes closer to the complete answer to the question.

13. The learning support system according to claim 9, wherein, in a case in which the answer by the learner is not input for a predetermined amount of time or more, the first processor of the display control apparatus generates the data for displaying on the display the advice information.

14. The learning support system according to claim 9, wherein, in a case in which the answer is an incorrect answer, or in a case in which the answer is a correct answer but information indicating a process leading up to the answer does not match a predetermined content, the first processor of the display control apparatus generates the data for displaying on the display the advice information.

15. A display control method executed by a display control apparatus, comprising:
based on a progress status of an input of an answer to a question by a learner with relation to a complete answer to the question, generating data for displaying on a display advice information used for solving the question.

16. The display control method according to claim 15, wherein in a case in which a request for the advice information is input from the learner, the data for displaying on the display the advice information is generated.

17. The display control method according to claim 16, wherein in a case in which the progress status is in a predetermined status, setting is made to not allow a request for the advice information from the learner to be acceptable.

18. The display control method according to claim 15, wherein the data for displaying on the display the advice information is generated with less amount of information as the progress status becomes closer to the complete answer to the question.

19. The display control method according to claim 15, wherein in a case in which the answer by the learner is not input for a predetermined amount of time or more, the data for displaying on the display the advice information is generated.

20. The display control method according to claim 15, wherein in a case in which the answer is an incorrect answer, or in a case in which the answer is a correct answer but information indicating a process leading up to the answer does not match a predetermined content, the data for displaying on the display the advice information is generated.
